(19) United States
(12) Patent Application Publication
(10) Pub. No.: US 2002/0189942 A1
(43) Pub. Date: Dec. 19, 2002

(54) Gas concentration measuring device

(76) Inventors: Mitsunobu Niwa, Kariya-shi (JP); Eiichi Kurokawa, Okazaki-shi (JP); Satoshi Hada, Inazawa-shi (JP)

Correspondence Address: NIXON & VANDERHYE P.C., 1100 North Glebe Rd., 8th Floor, Arlington, VA, 22201-4714, US

(21) Appl. No.: 10/171,588

(22) Filed: Jun. 17, 2002

(30) Foreign Application Priority Data
Jun. 15, 2001 (JP) 2001-181874

(51) Int. Cl. G01N 27/26

(52) U.S. Cl. 204/424

(57) ABSTRACT

A gas concentration-measuring device, which includes a gas concentration sensor, can measure the element resistance without affecting the gas concentration measurement. The sensing cells have a structure comprising a solid electrolyte element and electrodes so provided as to face each other with the solid electrolyte element between, and are kept active by heating the sensing cells in response to an element impedance of the solid electrolyte element. The sensing cells typically include a pump cell, a sensor cell and a monitor cell. A heater is imbedded in any solid electrolyte element. A sensor cell voltage is applied to the sensor cell while detecting a current that runs through the sensor cell. The concentration of the specific gas component in the subject gas is found from the detected current. In the element impedance measurement, the electronic circuit portion instantaneously changes a voltage applied to a cell used for element impedance measurement while detecting the element impedance from variations in voltage and current. In response to the element impedance, electric energy is applied to the heater so as to keep the cells active.

### BACKGROUND OF THE INVENTION

1. Field of the Invention

The invention relates to a gas concentration-measuring device of which the sensing cells have a structure comprising a solid electrolyte plate and electrodes so provided as to face each other with the solid electrolyte plate between and the sensing cells are kept active by heating the sensing cells in response to the element impedance of the solid electrolyte plate.

2. Description of the Prior Art

As such kind of gas concentration measuring devices, there are ones for measuring the concentration of, for example, nitrogen oxide (NOx) in vehicle exhaust gas by using gas concentration sensors of a limit current type. This kind of gas concentration measuring device has, for example, a three-cell structure comprising a pump cell for pumping oxygen out of the exhaust gas introduced into a chamber, a monitor cell for measuring the quantity of surplus (or remaining) oxygen in the remaining exhaust gas that has passed the pump cell, and a sensor cell for measuring the NOx concentration in the remaining exhaust gas.

Generally, the gas concentration-measuring device is provided with a heater for keeping the above-mentioned cells at a predetermined activation temperature. For this purpose, the heater current is so controlled as to cause the electric resistance of the solid electrolyte element (or plate) to correspond to the activation temperature by measuring the element resistance (or the electric resistance of the solid electrolyte element). Specifically, the current running the heater is feedback-controlled in response to the difference between the measurement and a target value of the element resistance.

As a technique of measuring the element resistance, there has been being used the sweep method through which the AC (alternating current) impedance is measured. Conventional gas concentration measuring devices measure the element resistance concerning the sensor cell by using the sweep method (as disclosed, for example, in Japanese unexamined patent publication NO. 2000-171439). Specifically, the voltage of the sensor cell is instantaneously changed to at least either of positive and negative sides during the measurement of element resistance, and the element resistance is found from the variation in voltage and current at the time. Thus measuring the element resistance concerning the sensor cell enables the suppression of the sensor cell temperature varying and the enhancement of accuracy in the NOx concentration measurement.

However, if the element resistance of the sensor cell is measured by using the sweep method, the NOx concentration measurement is impossible during the time period of element resistance measurement because the sensor cell voltage is instantaneously changed during the time period. That is, the time period of element resistance measurement is an immeasurable period for the NOx concentration. Further, it is necessary to delay the NOx concentration after the element resistance measurement until the sensor cell voltage completely converges on its original value. Thus, what is needed is a measure to cope with the immeasurable period for the NOx concentration.

The invention has been made to settle the above problem. Therefore, an object of the invention is to provide a gas concentration-measuring device capable of measuring the element resistance without affecting the gas concentration measurement.

### SUMMARY OF THE INVENTION

According to the principles of the invention, a gas concentration measuring device includes a gas concentration sensor, which in turn includes: a pump cell for pumping oxygen out of or into subject gas introduced into a chamber; a sensor cell for detecting the concentration of a specific gas component in passed subject gas that has passed the pump cell; a monitor cell for detecting the remaining oxygen concentration; and a heater for heating the above-mentioned cells. Each cell has a structure comprising a solid electrolyte element and electrodes so provided as to face each other with the solid electrolyte element between. The cells are kept active by heating the cells with the heater in response to an element impedance of an impedance-detected one of solid electrolyte elements. The gas concentration-measuring device further comprises an electronic circuit portion. Through the operation of the electronic circuit portion, a sensor cell voltage is applied to the sensor cell while detecting a current that runs through the sensor cell. The concentration of the specific gas component in the subject gas is found from the detected current. In the element impedance measurement, the electronic circuit portion instantaneously changes a voltage or current being applied to a cell used for element impedance measurement (or one of the cells that differs from the sensor cell and is provided in the impedance-detected solid electrolyte element) while detecting the element impedance from either variations in the voltage and a detected current or variations in the current and a detected voltage. In response to the element impedance, electric energy is applied to the heater so as to keep the cells active.

The sensor cell and an element impedance-measuring cell are preferably disposed in a range where there is substantially no temperature gradient.

The electric energy is so supplied as to make the element impedance equal to a desired target value.

In one embodiment, the element impedance is measured by using the pump cell which is provided in said one of the solid electrolyte elements or the impedance-measured solid electrolyte element.

In a preferred embodiment, the element impedance is measured by using the monitor cell which is provided in the impedance-measured solid electrolyte element. In this case, a sense resistor circuit is provided in a monitor cell current path and capable of evincing either of two values adapted for a remaining oxygen concentration measurement and the element impedance measurement in response to a control from external. In response to a command of alternating between the element impedance measurement and the remaining oxygen concentration measurement, the control is provided to the sense resistor means to cause the sense resistor means to evince one of the two values suited for the alternating.

In the preferred embodiment, both of the monitor cell and the sensor cell are preferably provided in a single solid electrolyte element. Further, the monitor cell and the sensor cell are preferably disposed in a range where there is substantially no temperature gradient.

In the preferred embodiment, on one side of the one of the solid electrolyte elements, one electrode of the monitor cell and one electrode of the sensor cell may be implemented as a single common electrode. It is also preferable to instantaneously change a voltage or current being applied to an electrode of the monitor cell that is other than the common electrode.

In one embodiment, said one of the solid electrolyte elements and a solid electrolyte element of the pump cell are facing in parallel with each other with a space between. An electrode of the pump cell provided on the outer side of the pump cell solid electrolyte element is exposed to a first air path. The common electrode of the monitor cell and the sensor cell is exposed to a second air path. And, the other electrodes of the pump cell, the monitor cell and the sensor cell are all exposed to the space.

The gas concentration sensor may further include one of a second pump cell and a second monitor cell. Again, the element impedance is preferably measured by using the cell closest to the sensor cell.

### BRIEF DESCRIPTION OF THE DRAWING

Further objects and advantages of the present invention will be apparent from the following description of the preferred embodiments of the invention as illustrated in the accompanying drawing, in which:

FIG. 1 is a schematic block diagram showing an arrangement of a gas concentration-measuring device in accordance with an illustrative embodiment of the invention;

FIGS. 2A and 2B are sectional side and end elevations showing the structure of a gas concentration sensor 100 shown in FIG. 1;

FIGS. 3A and 3B are horizontal section views showing electrode arrangements of the monitor cell and the sensor cell;

FIG. 4 is a flowchart showing a main routine executed by controller 200 of FIG. 1;

FIG. 5 is a flowchart showing a routine of measuring the impedance of monitor sensor 120;

FIG. 6 is a flowchart showing a routine of measuring the impedance of pump sensor 110 in accordance with a first modification of the illustrative embodiment of the invention; and

FIGS. 7 through 11 are transverse section views showing exemplary modifications of gas concentration sensor 100 of FIG. 2.

Throughout the drawing, the same elements when shown in more than one figure are designated by the same reference numerals.

### DETAILED DESCRIPTION OF THE PREFERRED EMBODIMENTS

A gas concentration-measuring device of the invention is suited for gasoline car engines for example. The gas concentration-measuring device, which uses limit current-type gas concentration sensors, measures the oxygen concentration in the gas to be measured or the exhaust gas and at the same time measures the NOx concentration as the concentration of a specific target gas.

Embodiment

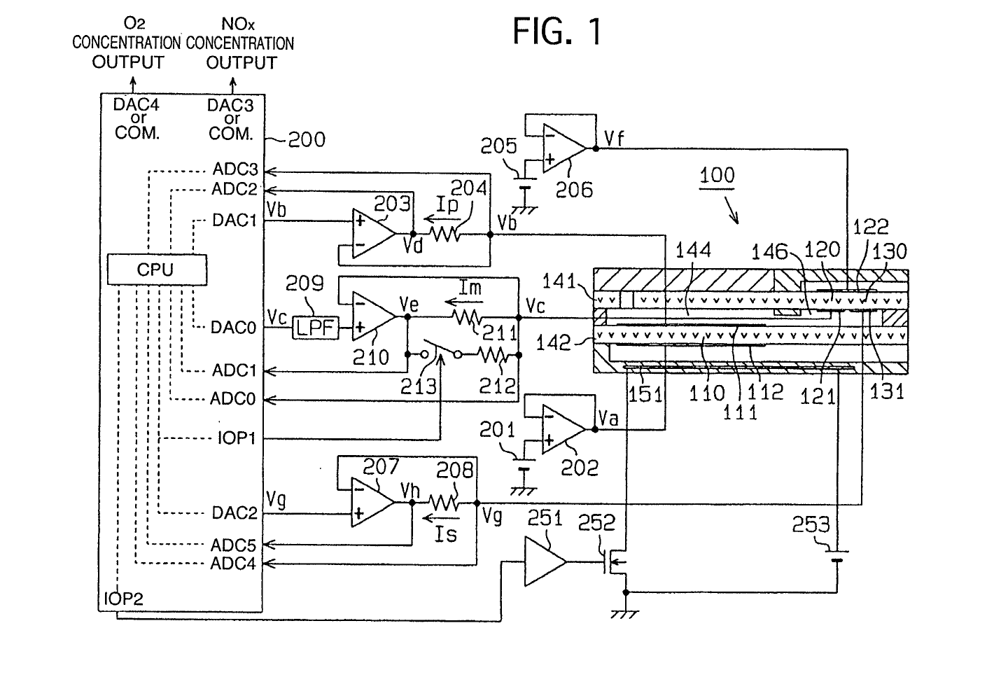

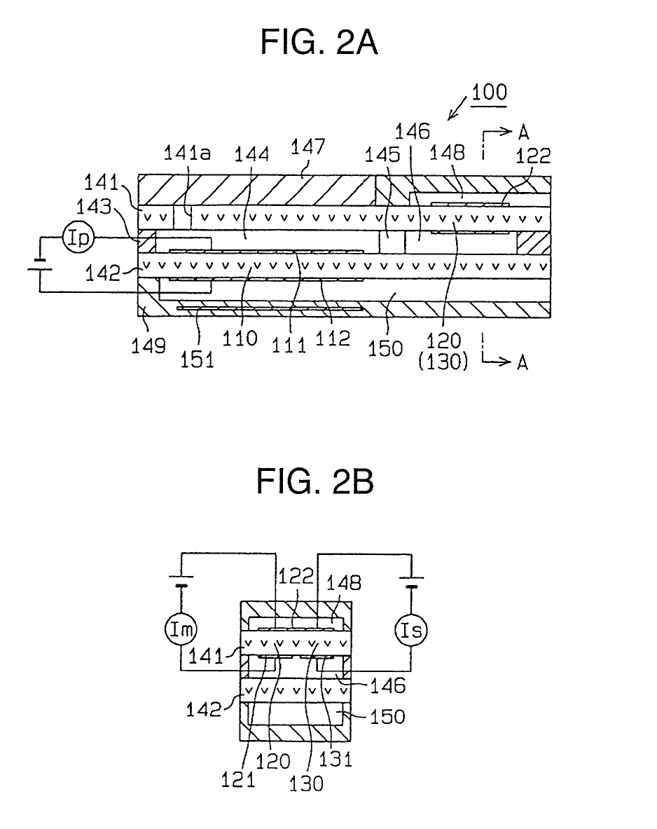

FIG. 1 is a schematic block diagram showing an exemplary arrangement of a gas concentration-measuring device in accordance with an illustrative embodiment of the invention. The gas concentration-measuring device of FIG. 1 is a so-called combined-type gas concentration-measuring device capable of simultaneous measurement of oxygen and NOx concentrations with a triple-cell structure comprising a pump cell, a monitor cell and a sensor cell. FIG. 2A is a sectional side elevation showing the structure of a gas concentration sensor 100 (shown in FIG. 1) and FIG. 2B is a sectional end elevation taken along the line A-A of FIG. 2A. Referring to FIG. 2, gas concentration sensor 100 will be first described in the following.

In FIG. 2A, gas concentration sensor 100 comprises solid electrolytes (referred to as “solid electrolyte elements”) 141 and 142 which are plates of oxygen ion-conductive material(s); a spacer 143 provided between the solid electrolyte elements 141 and 142 and made of an insulating material such as alumina; a porous diffusion layer 147 mounted on the outer side of solid electrolyte element 141; and a insulator layer 149 so made and disposed as to provide an air passage 150 between the inner wall thereof and the outer side of solid electrolyte element 142. Solid electrolyte element 141 has a pinhole 141a formed therein. Exhaust gas around gas concentration sensor 100 is introduced into a first chamber 144 through pinhole 141a. The first chamber 141a communicates with a second chamber 146 through a choke portion 145.

Solid electrolyte element 142 shown in lower side has pump cell 110 formed by providing a pair of electrodes 111 and 112 on both sides of solid electrolyte element 142 such that the horizontal range of pump cell 110 or electrode 111 is contained in the first chamber 144. Electrode 111 is inert with respect to NOx (i.e., hardly resolves NOx gas).

Pump cell 110 pumps oxygen out of or into the exhaust gas introduced in the first chamber 144 while measuring the oxygen concentration in the exhaust gas. In this case, pump cell 110 resolves and pumps out oxygen within the first chamber 144 to the air passage 150 from electrode 112.

If the first chamber 144 is rich in a target gas component, pumping oxygen out of or into the 144 with pump cell 110 can cause the first chamber 144 to approach the lean state, resulting in the oxygen concentration in the exhaust gas being stabilized. Thus, gas concentration sensor 100 provides a good response even to a sudden change in the oxygen concentration in the exhaust gas.

Also, solid electrolyte element 141 shown in upper side is provided with monitor cell 120 and sensor cell 130 such that one electrode of each of cells 120 and 130 faces the second chamber 146. Monitor cell 120 generates a current output in response to the concentration of surplus (or remaining) oxygen within the second chamber 146 and the voltage applied to monitor cell 120. Sensor cell 130 detects the NOx concentration in the exhaust gas that has passed pump cell 110.

In this specific embodiment of the invention, as shown in FIG. 2B, monitor cell 120 and sensor cell 130 are so disposed in parallel as to be equally positioned with respect to the direction of exhaust gas flow in the second chamber 146, and have a common electrode 122 so provided on the outer side of solid electrolyte element 141 as to face an air passage 148. Specifically, monitor cell 120 comprises solid electrolyte element 141, and an electrode 121 and the common electrode 122 so disposed as to face each other with solid electrolyte element 141 between, while sensor cell 130 comprises solid electrolyte element 141, and an electrode 131 and the common electrode 122 so disposed as to face each other with solid electrolyte element 141 between. Also, electrode 121 of monitor cell 120, which is exposed to the second chamber 146, is made of precious metal inert to NOx gas: e.g., Au—Pt, while electrode 131 of sensor cell 130, which is exposed to the second chamber 146, is made of precious metal active to NOx gas: e.g., Pt.

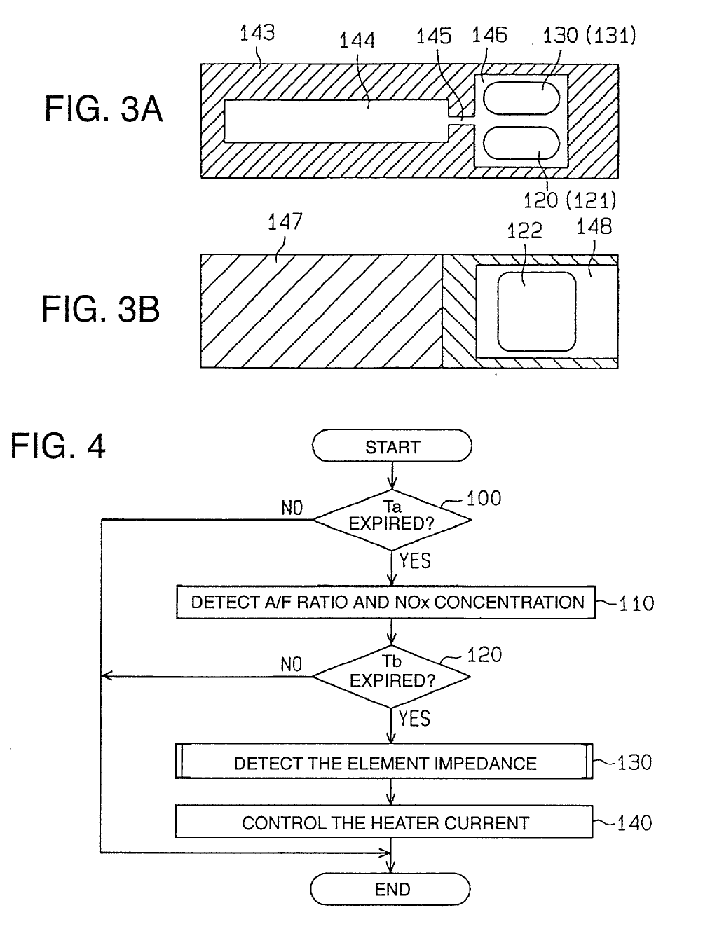

FIG. 3A is a horizontal section so taken as to permit electrodes 121 and 131 of monitor 120 and sensor 130 cells to be viewed from the second chamber 146 side. FIG. 3B is a horizontal section so taken as to permit common electrode 122 of cells 120 and 130 to be viewed from the air passage 148 side. It is noted that, instead of being arranged in parallel along the flow of exhaust gas as shown in FIG. 3A, monitor cell 120 and sensor cell 130 may be arranged up and down the flow of exhaust gas (i.e., in the right and left side within the second chamber 146 in FIG. 3B). For example, monitor cell 120 and sensor cell 130 are positioned in the upstream (or in the left side) and the downstream (or in the right side), respectively.

Turning now to FIG. 2A, above-mentioned insulator layer 149 has a heater 151 embedded therein. With electric power supplied from the external, heater 151 generates thermal energy to heat the whole gas concentration sensor 100 including pump cell 110, monitor cell 120 and sensor cell 130.

In thus configured gas concentration sensor 100, exhaust gas is introduced through porous diffusion layer 147 and pinhole 141a into the first chamber 144. As the introduced exhaust gas passes the neighborhood of pump cell 110, applying an appropriate voltage between pump cell 110 electrodes 111 and 112 causes the resolution reaction to resolve only oxygen while pump cell 110 pumping the resolved oxygen out of the first chamber 144 into air passage 150. This is because the pump cell 110 electrode of the first chamber 144 side or electrode 111 is inert to NOx, resulting in only oxygen in the introduced exhaust gas being resolved without NOx in the introduced exhaust gas being resolved. The oxygen concentration in the exhaust gas is measured from the current running through pump cell 110.

The exhaust gas that has passed the neighborhood of pump cell 110 flows into the second chamber 146, thereby to cause monitor cell 120 which has a predetermined monitor cell voltage applied between its electrodes 121 and 122 to generate a monitor cell current in response to the concentration of surplus oxygen in the exhaust gas. Concurrently, a part of the exhaust gas within the second chamber 146 contacts electrode 131 of sensor cell 130 which has a predetermined sensor cell voltage applied between its electrodes 131 and 122, thereby to cause NOx gas in the contacted exhaust gas to be reduced or resolved. Oxygen resulted from the reduction is issued into the air passage 148, resulting in a sensor cell current running through sensor cell 130. The NOx concentration in the exhaust gas is found from the sensor cell current.

Referring to FIG. 1, an exemplary electrical arrangement of gas concentration measuring device of the invention will be detailed in the following. Though FIG. 1 shows a gas concentration measuring device which uses above-described gas concentration sensor 100, monitor cell 120 and sensor cell 130 are shown as disposed up and down the exhaust gas flow for the sake of convenience.

In FIG. 1, controller 200 has a well-known CPU-based (central processing unit-based) structure which comprises a CPU, analog-to-digital converters ADCO-ADC5, digital-to-analog converters DAC0-DAC4 and input and output ports IOP1 and IOP2. Controller 200 supplies cells 110-130 with respective appropriate voltages from DAC0-DAC2, respectively. In order to measure the currents that run through cells 110-130, controller 200 inputs node voltages Vc, Ve, Vd, Vb, Vg and Vh from respective converters ADCO-ADC5. Controller 200 finds the oxygen concentration and the NOx concentration in the exhaust gas from the measured currents for cells 110-130 and outputs the oxygen and NOx concentrations from converters DAC4 and DAC3.

Further in FIG. 1, a reference voltage Va is applied to one electrode 112 of pump cell 110 by means of reference power supply 201 and operational amplifier 202, and controller 200 applies a command voltage Vb to the other electrode 111 of pump cell 110 through operational amplifier 203 and sense (or current-sensing) resistor 204. When a current runs through pump cell 110 depending on the oxygen concentration in the exhaust gas in response to the application of the command voltage Vb, the current is detected by the sense resistor 204. Specifically, controller 200 takes in voltages Vb and Vd at both ends of the sense resistor 204 and calculates the pump cell 110 current Ip from the voltage Vb and Vd.

Also, a reference voltage Vf is applied to common electrode 122 of monitor cell 120 and sensor cell 130 by means of reference power supply 205 and operational amplifier 206, and controller 200 applies a command voltage Vg to the electrode of sensor cell 130 other than common electrode 122, i.e., electrode 131, through operational amplifier 207 and sense resistor 208. When, with the application of the command voltage Vg, a current runs through sensor cell 130 depending on the NOx concentration in the exhaust gas, the current is detected by the sense resistor 208. Specifically, controller 200 takes in voltages Vg and Vh at both ends of the sense resistor 208 and calculates the sensor cell 130 current Is from the voltage Vg and Vh.

Also, controller 200 applies a command voltage Vc to the electrode of monitor cell 120 other than common electrode 122, i.e., electrode 121 through LPF (low pass filter) 209, operational amplifier 210 and sense resistance 211. When, with the application of the command voltage Vc, a current runs through monitor cell 120 depending on the NOx concentration in the exhaust gas, the current is detected by the sense resistor 211. Specifically, controller 200 takes in voltages Vc and Ve at both ends of the sense resistor 211 and calculates the monitor cell 120 current Im from the voltage Vc and Ve. It is noted that LPF 209 may be implemented, for example, as a primary filter comprised of a resistor and a capacitor.

The present embodiment is so arranged as to detect the element impedance concerning monitor cell 120 by using the sweeping method. Specifically, if the impedance of monitor cell 120 is to be detected, then controller 200 instantaneously changes the monitor cell 120 voltage or command voltage Vc to at least one of positive and negative sides. The monitor cell 120 voltage is smoothed like a sine wave by LPF 209 and applied to monitor cell 120. The frequency of the AC voltage is preferably more than 10 kHz, and the time constant of LPF 209 is preferably set to about 5 μs. The element impedance of monitor cell 120 is calculated from the variations in voltage and current in this state.

Since one electrode of each of monitor cell 120 and sensor cell 130 is realized as the common electrode 122, the reference voltage driving circuit is advantageously simplified and the lead conductors of gas concentration sensor 100 are preferably reduced in number. Also, since monitor cell 120 and sensor cell 130 are formed adjacently to each other in the same solid electrolyte element 141, though it may be feared that sweeping one cell voltage causes a current in the other electrode, resulting in deterioration in the accuracy of impedance detection, providing the common electrode 122 makes one electrode 122 at the same potential, which enables an reduction in the adverse affection

It should be noted that while monitor cell 120 passes a current of only a few μ. A during the remaining (or surplus) oxygen concentration detection, monitor cell 120 passes a current on the order of milliampere during voltage sweeping for impedance detection. Measuring currents of different orders with an identical sense resistor causes an over range or a degradation in measurement accuracy. For this purpose, the gas concentration-measuring device of the invention is so configured as to shift the sense resistor between two values for the remaining oxygen concentration detection and the element impedance detection.

Specifically, this is achieved by adding a leg of additional sense resistor 212 and switch circuit 213 such as a semiconductor switch in parallel with the sense resistor 211 and by turning switch circuit 213 on and off with an output signal from I/O port IOP1 of controller 200. In this case, in usual gas concentration measurement, with switch circuit 213 kept off or open, the monitor cell 120 current Im is detected by using a resistor of about several hundreds kΩ due to sense resistor 211. In element impedance detection, with switch circuit 213 kept on or closed, the monitor cell 120 current Im is detected by using a resistor of several hundreds Ω due to parallelly connected sense resistors 211 and 212.

Also, controller 200 output a pulse signal with a desired duty from I/O port IOP2 to drive MOSFET (metal-oxide semiconductor field-effect transistor) driver 251, which in turn provides the PWM (pulse width modulation) control to the electric power supplied from power supply 253 (e.g., a battery) to heater 151.

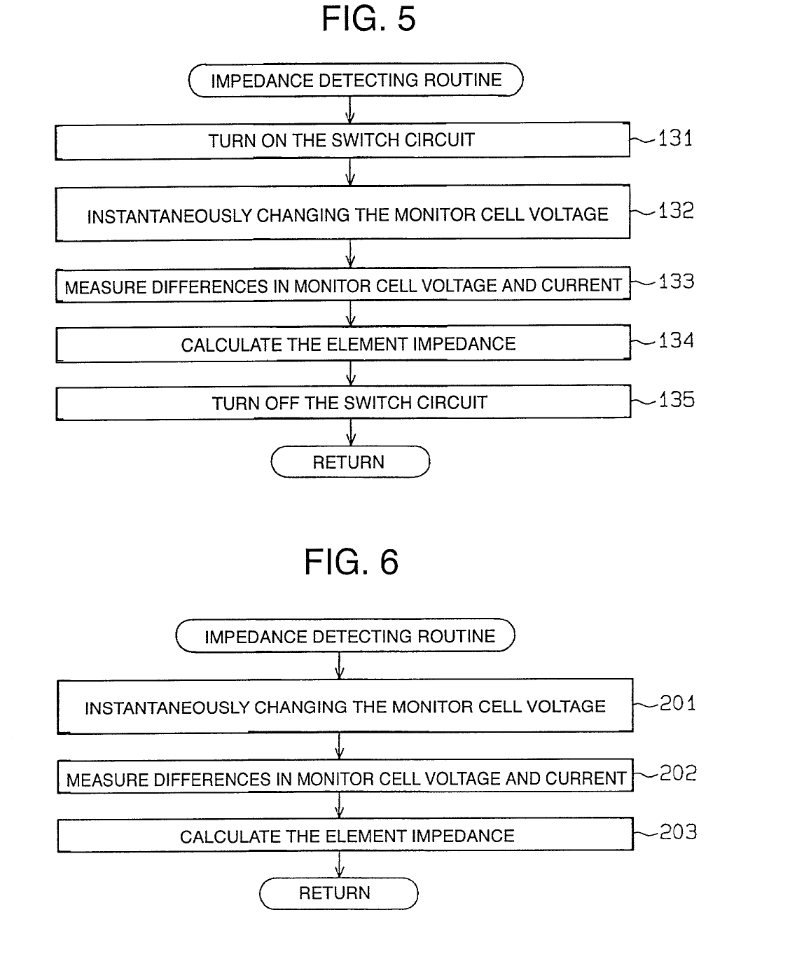

Referring to FIGS. 4 and 5, the operation of gas concentration measuring device of the invention will be described in the following. FIG. 4 is a flowchart showing a main routine executed by controller 200 of FIG. 1. Controller 200 invokes the main routine in response to a power-on.

In FIG. 4, controller 200 makes a test, in step 100, to see if a predetermined time Ta has passed since the last measurements of A/F (air-to-fuel ratio) (i.e., the oxygen concentration) and the NOx concentration. Ta is a time interval corresponding to a period of detecting A/F and the NOx concentration and is set to about 4 m sec for example. If the result is YES in step 100, then controller 200 proceeds to step 110, where controller 200 measures A/F (or the oxygen concentration) and the NOx concentration.

In A/F measurement, the pump cell 110 current Ip is detected while almost continuously controlling the pump cell 110 voltage in response to the detected pump cell current Ip. The detected current Ip is converted into an A/F value. On the other hand, in NOx concentration measurement, the sensor cell 130 current Is is detected while keeping the sensor cell 130 voltage at a predetermined value. The detected sensor cell 130 current Is is converted into a NOx concentration.

After measuring A/F and the NOx concentration, controller 200 makes a test, in step 120, to see if a second predetermined time Tb has passed since the last element impedance measurement. The second predetermined time Tb is a time interval corresponding to a period of detecting the element impedance Zac and is selectively set to a value ranging from 128 m sec to 2 sec for example. If the result is YES in step 120, then controller 200 measures the element impedance Zac in step 130 and adjusts the current through heater 151 in step 140. The element impedance Zac detection is detailed later.

The heater current control may be carried out by any suitable method that controls the heater current so as to cause the element impedance Zac to accord with a target value. For example, if the temperature of solid electrolyte elements 141 and 142 of gas concentration sensor 100 is low and accordingly the element impedance Zac is relatively large, then controller 200 makes the duty factor of the heater current 100%. As the element temperature goes up, controller 200 calculates an appropriate duty factor by using the well-known PID technique and flows a current of the calculated duty factor through the heater 151.

Referring now to FIG. 5, the element impedance measurement in step 130 of FIG. 4 is detailed in the following. In FIG. 5, controller 200 shifts the switch circuit 213 from off to on in step 131, causing the value of sense resistance that has been on the order of several hundreds kΩ to change to about 100 Ω. Then instep 132, controller 200 instantaneously change the monitor cell 120 voltage that has been kept at a predetermined command voltage Vc for remaining oxygen concentration measurement to the positive side for a single moment of 10-100 μsec.

Controller 200 reads the variation of monitor cell 120 voltage and the variation of monitor cell 120 current Im in step 133, calculates the element impedance Zac from the read voltage variation and current variation as:

Zac32 voltage variation/current variation

in step 134, changes the switch circuit 135 from on to off in step 135, and returns to the main routine of FIG. 4.

According to the above-described embodiment of the invention, since the element impedance Zac is measured by using monitor cell 120 of gas concentration sensor 100, the element impedance Zac is advantageously measured without interrupting any of the NOx concentration measurement in sensor cell 130 and the A/F (or oxygen concentration) measurement in pump cell 110.

Further, since monitor cell 120 and sensor cell 130 are disposed close to each other (such that the temperature gradient between cells 120 and 130 can be negligible), controlling the heater current on the basis of the element impedance Zac of monitor cell 120 enables keeping not only monitor cell 120 but also sensor cell 130 in a desired active condition. That is, the variation of sensor cell 130 temperature can be suppressed, which enhances the accuracy of NOx concentration measurement.

Also, in gas concentration sensor 100, monitor 120 and sensor 130 cells share a common electrode and the element impedance Zac is measured by instantaneously changing the monitor cell voltage applied to the electrode of monitor cell 120 which is other than the common electrode. This enables the simplification of structure and an accurate impedance measurement. However, instead of providing the common electrode, monitor cell 120 and sensor cell 130 have their respective electrodes on both sides of solid electrolyte element 141. In this case, an electrode of which the voltage is to be changed for the impedance measurement may be either of the electrodes of monitor cell 120.

Since the gas concentration measuring device of the invention is so arranged as to use two different values of the sense resistor for the remaining oxygen concentration measurement and the element impedance measurement by means of monitor cell 120, this eliminates disadvantages such as the over range and a degradation of measurement accuracy.

Modifications

In the above-described embodiment, the element impedance has been measured by using monitor cell 120. However, a first modification of the embodiment measures the element impedance by using pump cell 110.

The points in which the first modification differs from the above embodiment are that: in the first modification,

LPF 209 has been moved from DAC0 output circuit to DAC1 output circuit so as to smooth the DAC1 output for the element impedance measurement by pump cell 110;

the element impedance is measured in accordance with a flowchart of FIG. 6 instead of FIG. 5; and

a serial circuit of switch 213 and resistor 212 has been removed.

In FIG. 6, controller 200 instantaneously changes the pump cell 110 voltage, which has been set to the command voltage Vb for the A/F measurement, to the positive side for a single moment of 10-100 μsec in step 201; takes in the variation of the pump cell 110 voltage and the variation of the pump cell 110 current in step 202; and calculates the element impedance Zac from the voltage variation and the current variation in step 203 (Zac=voltage variation/current variation).

It is noted that in case of the element impedance Zac being measured with pump cell 110, the pump cell 110 current is of several mA in both of the A/F measurement and the impedance measurement. For this reason, there is no need of providing a switch circuit for shifting the sense resistance values as shown in FIG. 1.

According to the just-described first modification, since the element impedance Zac is measured by using pump cell 110 of gas concentration sensor 100, again the element impedance Zac is advantageously measured without interrupting the NOx concentration measurement in sensor cell 130.

Also, since pump cell 110 is maintained in a desired active condition, the oxygen exhaust function by pump cell 110 works properly thereby to keep the surplus oxygen concentration within chamber constantly. This ensures the accuracy of NOx concentration measurement.

A wide variety of modifications are possible for the above-described illustrative embodiment.

For example, the gas concentration measuring devices have used gas concentration sensor 100 so far, the invention can be implemented by using other suitable gas concentration sensors. Some applicable gas concentration sensors will be described in the following. In the following gas concentration sensors, the same elements as shown in FIG. 2 are designated by the same reference numerals, and their descriptions are omitted. As for any of the following gas concentration sensors, the element impedance can be measured either by using monitor cell 120 and the impedance measuring routine of FIG. 5 or by using pump cell 110 and the impedance measuring routine of FIG. 6.

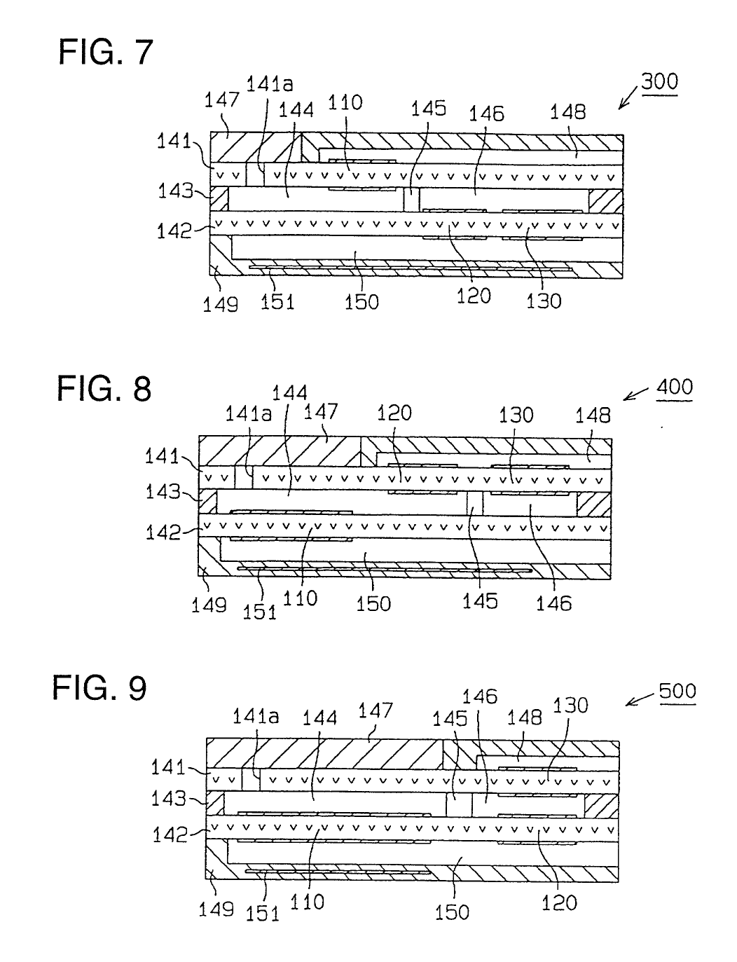

In gas concentration sensor 300 of FIG. 7, pump cell 110 is provided in upper solid electrolyte element 141, and monitor cell 120 and sensor cell 130 are provided in lower solid electrolyte element 142. In other words, as compared with FIG. 2, cells 110, 120 and 130 are reversely positioned in upper 141 and lower 142 solid electrolyte elements. Also, as described above, monitor cell 120 and sensor cell 130 has only to be disposed close to and in parallel with each other so as to be equally positioned with respect to the flow of exhaust gas (or such that there is substantially no temperature gradient between cells 120 and 130). As long as this condition is satisfied, monitor cell 120 and sensor cell 130 may be disposed either up and down the flow of exhaust gas or in the right and left sides of the center line of the exhaust gas flow.

Gas concentration sensor 400 of FIG. 8 is fundamentally identical to that of FIG. 2 except that, in FIG. 8, monitor cell 120 has been moved to the first chamber 144 and accordingly the air passage 148 has been so lengthened as to completely contain the moved monitor cell 120.

Gas concentration sensor 500 of FIG. 9 is fundamentally identical to that of FIG. 2 except that, in FIG. 9, monitor cell 120 has been provided in lower solid electrolyte element 142 instead of upper solid electrolyte element 141. That is, monitor cell 120 and sensor cell 130 are provided in different solid electrolyte elements but are facing an identical chamber.

Again, in the above-mentioned gas concentration sensors, monitor cell 120 and sensor cell 130 are disposed relatively close to each other or in a range where there is substantially no temperature gradient. The impedance control in monitor cell 120 yields similar control of sensor cell 130. It is noted that the invention can be also embodied by using a gas concentration sensor with more than three cells.

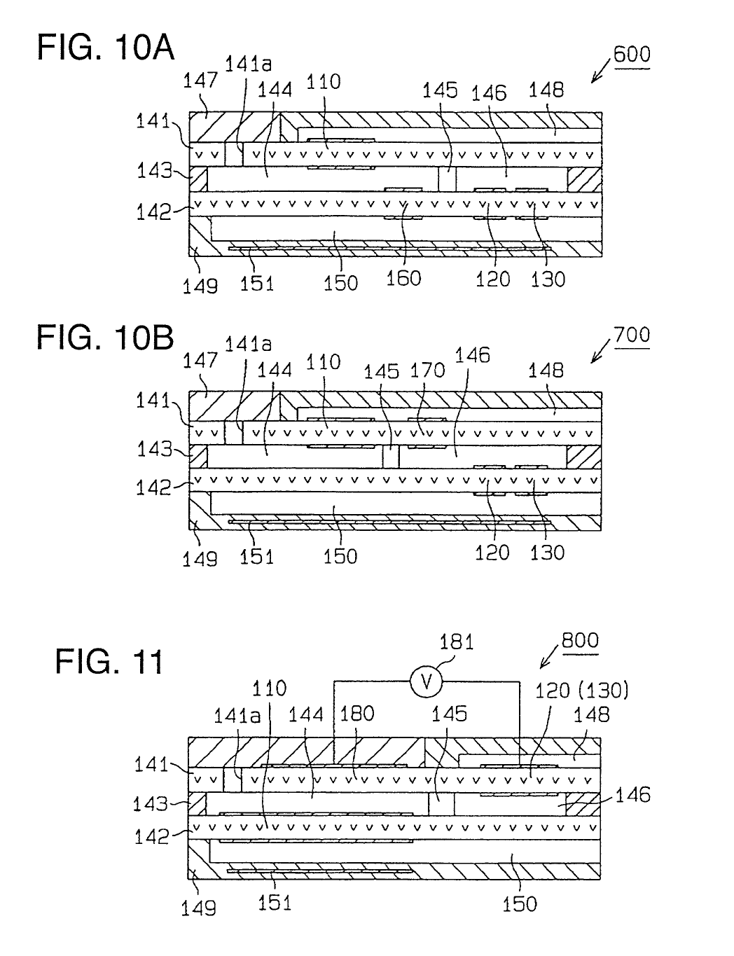

FIGS. 10A and 10B are schematic diagrams each showing exemplary gas concentration sensor with four cells. Gas concentration sensor 600 of FIG. 10A is fundamentally identical to that of FIG. 7 except that, in FIG. 10A, an additional second monitor cell 160 has been provided in lower solid electrolyte element 142 so as to face the first chamber 144. Gas concentration sensor 700 of FIG. 10B is fundamentally identical to that of FIG. 7 except that, in FIG. 10B, an additional second pump cell 170 has been provided in upper solid electrolyte element 141 so as to face the second chamber 146. In gas concentration measuring devices using these gas concentration sensors 600 and 700, the element impedance measurement is preferably made by using a cell closest to sensor cell 130. For example, the element impedance measurement is preferably made by using monitor cell 120 in both FIGS. 10A and 10B. However, newly added cells 160 and 170 may be used for the element impedance measurement in gas concentration sensors 600 and 700. In such cases, using the second pump cell 170 in gas concentration sensor 700 of FIG. 10B will be rather better than using the second monitor cell 160 in gas concentration sensor 600 of FIG. 10A. As is a matter of course, the invention is applicable to gas concentration sensors with more than four cells.

In addition to pump cell 110, monitor cell 120 and sensor cell 130, a gas concentration sensor may be provided with a cell dedicated for the element impedance measurement. For example, such an impedance-measuring cell may be provided either in the solid electrolyte element in which sensor cell 130 is provided or in the chamber which sensor cell 130 faces. Again the element impedance is measured by instantaneously changing the voltage of the impedance-measuring cell in the same manner as described above.

FIG. 11 is a section view showing an exemplary structure of a gas concentration sensor to which the invention is applicable and in which a λ cell is provided near the pump cell 110. The λ cell provides an electromotive force depending on the oxygen concentration within the chamber. In FIG. 11, λ cell 180 is provided in upper solid electrolyte element 141. The electromotive force by λ cell 180 is measured by voltage meter 181. The measurement of electromotive force is taken in by controller 200.

It is noted that the electrodes of monitor cell 120 and sensor cell 130 do not necessarily have to be rectangular in shape but may have any suitable respective shapes. If monitor cell 120 and sensor cell 130 are so disposed as to be equally positioned with respect to the exhaust gas flow as in gas concentration sensor 100 of FIG. 2, then electrodes 121 and 131 of monitor 120 and sensor 130 cells may be waved or comb teeth-shaped in the adjacent sides. Also, electrodes 121 and 131 may have asymmetric shapes.

In the above description, the voltage of monitor cell 120 or pump cell 110 has been changed for impedance measurement. Alternatively, the current that runs through monitor cell 120 or pump cell 110 may be instantaneously changed. In either case, the element impedance is found from the voltage variation and the current variation at that time.

The present invention is applicable not only to gas concentration sensors capable of measuring the NOx gas concentration but also to gas concentration sensors capable of measuring the HC concentration or the CO concentration as the concentration of a specific gas component. In such a case, surplus oxygen in the exhaust gas is first exhausted by using a pump cell, and the HC or CO concentration in the remaining exhaust gas is detected by using a sensor cell.

The invention is also applicable to various gas concentration measuring devices for use in other than vehicle. That is, the invention can be applied to the detection of the concentration of gas other than exhaust gas.

Many widely different embodiments of the present invention may be constructed without departing from the spirit and scope of the present invention. It should be understood that the present invention is not limited to the specific embodiments described in the specification, except as defined in the appended claims.

What is claimed is:

1. A gas concentration measuring device comprising:
a gas concentration sensor including:
a pump cell for pumping oxygen out of or into subject gas introduced in a chamber;
a sensor cell for detecting a concentration of a specific gas component in passed subject gas that has passed said pump cell;
a monitor cell for detecting a remaining oxygen concentration; and
a heater for heating said cells,
wherein each cell has a structure comprising a solid electrolyte element and electrodes so provided as to face each other with the solid electrolyte element between, and
wherein said cells are kept active by heating said cells with said heater in response to an element impedance of one of said solid electrolyte elements, the gas concentration measuring device further comprising:
applying means for applying a sensor cell voltage to said sensor cell while detecting a current that runs through said sensor cell;
finding means for finding the concentration of said specific gas component in said subject gas from said detected current;
detecting means activated in element impedance measurement for instantaneously changing a voltage or current being applied to one of said cells that differs from said sensor cell and is provided in said one of said solid electrolyte elements while detecting said element impedance from either variations in said voltage and a detected current or variations in said current and a detected voltage; and
supplying means for supplying electric energy to said heater so as to keep said cells active in response to said element impedance.

2. A gas concentration measuring device as defined in claim 1, wherein said sensor cell and said one of said cells that differs from said sensor cell are disposed in a range where there is substantially no temperature gradient.

3. A gas concentration measuring device as defined in claim 1, wherein said supplying means comprises means for supplying electric energy so as to make said element impedance equal to a desired target value.

4. A gas concentration measuring device as defined in claim 1, wherein said one of said cells that differs from said sensor cell is said pump cell, and said one of said solid electrolyte elements is a solid electrolyte element in which said pump cell is provided.

5. A gas concentration measuring device as defined in claim 1, wherein said one of said cells that differs from said sensor cell is said monitor cell, and said one of said solid electrolyte elements is a solid electrolyte element in which said monitor cell is provided.

6. A gas concentration measuring device as defined in claim 5, wherein said detecting means includes sense resistor means provided in a monitor cell current path and capable of evincing either of two values adapted for a remaining oxygen concentration measurement and said element impedance measurement in response to a control from external, the gas concentration measuring device further including means responsive to a command of alternating between said element impedance measurement and said remaining oxygen concentration measurement for providing said sense resistor means with said control to cause said sense resistor means to evince one of said two values suited for said alternating.

7. A gas concentration measuring device as defined in claim 1, wherein both of said monitor cell and said sensor cell are provided in a single one of said solid electrolyte elements.

8. A gas concentration measuring device as defined in claim 7, wherein said monitor cell and said sensor cell are disposed in a range where there is substantially no temperature gradient.

9. A gas concentration-measuring device as defined in claim 8, wherein:
said one of said cells is said monitor cell;
said monitor cell and said sensor cell are provided in said one of said solid electrolyte elements;
on one side of said one of said solid electrolyte elements, one electrode of said monitor cell and one electrode of said sensor cell are implemented as a single common electrode; and
said detecting means includes means for instantaneously changing a voltage or current being applied to an electrode of said monitor cell that is other than said common electrode.

10. A gas concentration-measuring device as defined in claim 9, wherein:
said one of said solid electrolyte elements and a solid electrolyte element of said pump cell are facing in parallel with each other with a space between;
an electrode of said pump cell provided on a outer side of said pump cell solid electrolyte element is exposed to a first air path;
said common electrode of said monitor cell and said sensor cell is exposed to a second air path; and
the other electrodes of said pump cell, said monitor cell and said sensor cell are all exposed to said space.

11. A gas concentration-measuring device as defined in claim 1, wherein:
said gas concentration sensor further including one of a second pump cell and a second monitor cell; and
said one of said cells is a cell closest to said sensor cell.
